(19) United States
(12) Patent Application Publication
(10) Pub. No.: US 2009/0327229 A1
(43) Pub. Date: Dec. 31, 2009

(54) AUTOMATIC KNOWLEDGE-BASED GEOGRAPHICAL ORGANIZATION OF DIGITAL MEDIA

(75) Inventors: Tim O'Connor, Redmond, WA (US); Tomasz Kasperkiewicz, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,573

(22) Filed: Jun. 27, 2008

(51) Int. Cl. G06F 7/06; G06F 17/30

(52) U.S. Cl. 707/3; 707/104.1; 707/E17.014; 707/E17.01

(57) ABSTRACT

Various techniques for a method for generating location information for a digital media file. In one implementation, the method may include receiving a first digital media file with location information and a second digital media file without location information, receiving a location hierarchy of the first digital media file, wherein the location hierarchy is determined using a reverse-geocoding algorithm and using the location hierarchy of the first digital media file to determine a location hierarchy of the second digital media file.

### BACKGROUND

Few digital cameras are capable of embedding location references, such as the latitude and longitude coordinates, of a picture into a picture file. The cameras that do have that capability include data from a built-in or attached Global Positioning System (GPS) device such that digital photographs taken with the camera will obtain the camera's latitude and longitude coordinates and embed them into the corresponding picture file. Other methods of attaching latitude and longitude on an image file include using a GPS logger (i.e., a device that writes location/time information to a file) to associate the latitude and longitude coordinates of the camera with the pictures that were taken at the same time. This method is limited in that the GPS device may not have logged coordinates at the exact time that the picture files were taken and that the camera and logger clocks may not be perfectly synchronized.

Most digital pictures, however, are taken and stored without an opportunity or option to embed latitude and longitude coordinates into the picture file. Certain software packages exist that may allow users to indicate where a picture was taken on a digital map and embed those latitude and longitude coordinates on a picture file, but the map designated location may be too narrow for the user's purpose. The problem with existing methods and packages may include the fact that the latitude and longitude coordinates are rarely directly usable by the end user. For example, latitude and longitude coordinates, 47.61980 N and 122.34880 W, may be of little use for the user because they may not indicate the user's intended location classification.

### SUMMARY

Described herein are implementations of various technologies for automatically generating location reference for digital picture files. In one implementation, a user may indicate the memory location of a particular batch of digital picture files to a program. The program may examine the picture files of the batch and distinguish between the picture files with location references embedded within the files (picture files with known locations) and the picture files without location references embedded within the files (picture files with unknown locations). The program may then send a request to a server to provide a location hierarchy for each picture file with a known location.

After receiving the location hierarchy for the picture files with known locations, the program may begin to calculate the locations of the picture files with unknown locations. Here, the program may utilize a variety of algorithms in order to determine the location reference of the picture files with unknown locations. After determining the location reference of each picture file with unknown locations, the program may embed the calculated location reference into the picture file with unknown location.

The program may then display to the user the location references for each picture file in the batch. The user may then verify the locations of one or more of the picture files. If the user is unsatisfied with the location of one or more picture files, he may indicate to the program the correct location of the one or more picture files. Upon receiving changes to the location references of one or more picture files, the program may again calculate the location reference of each picture file with unknown location or calculated location in the batch to determine a more accurate representation of the location reference.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for associating a location reference to picture files in accordance with one or more implementations of various techniques described herein.

### DETAILED DESCRIPTION

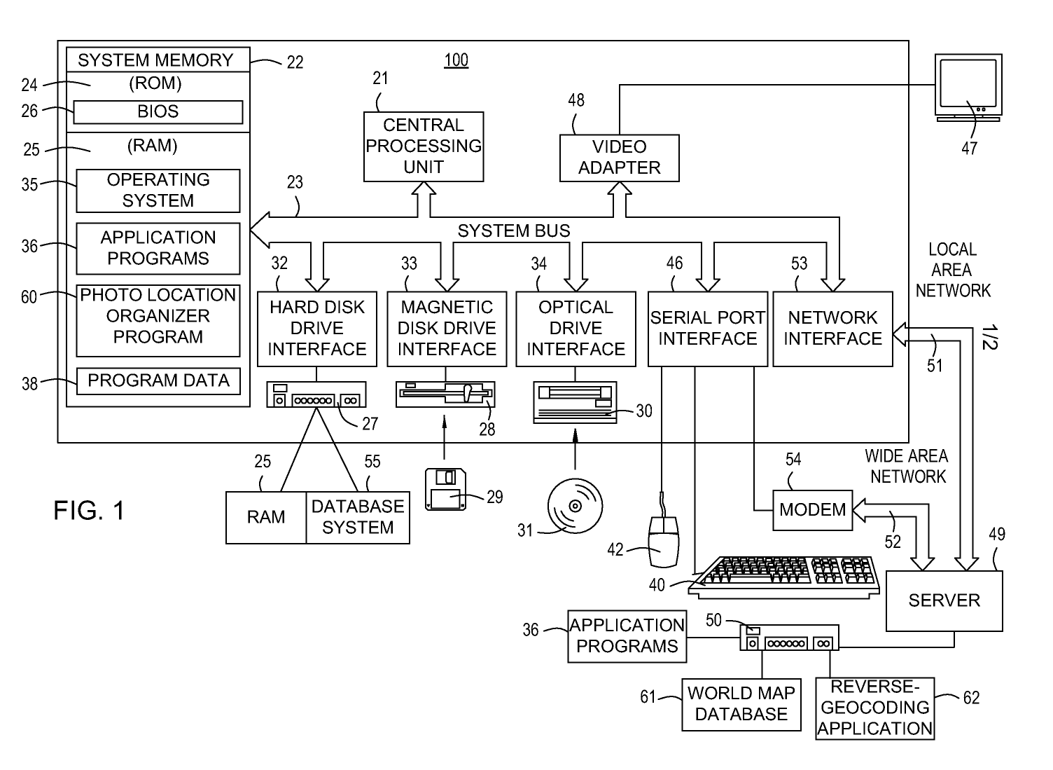

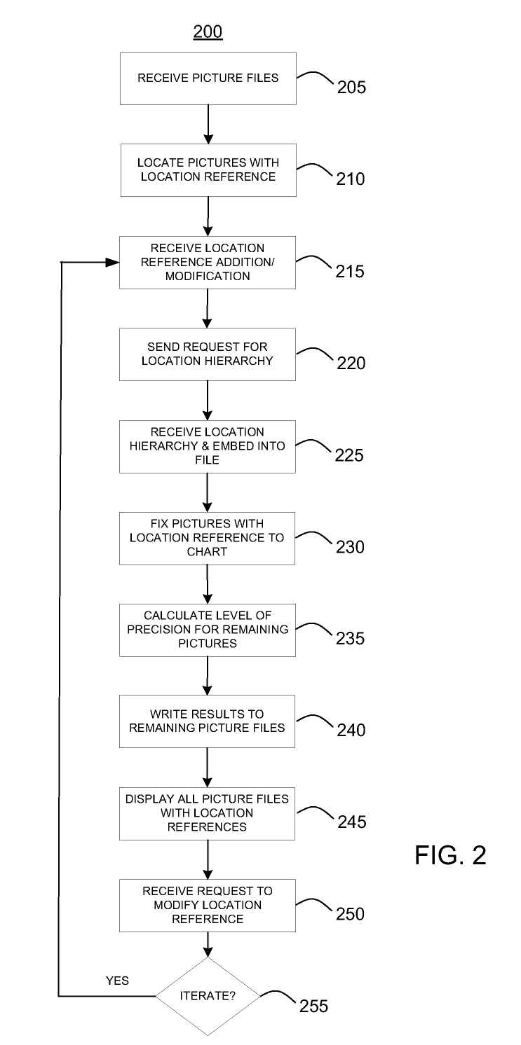

In general, one or more implementations described herein are directed to determining the locations of picture files that do not contain location references. In some instances, only a few picture files in a particular batch of picture files may have location references, such as latitude and longitude coordinates, embedded in their files. In one implementation, a program may automatically determine the location reference of each picture file with unknown locations using the location references of the picture files with the location references. One or more implementations of various techniques for determining the locations of picture files with unknown locations will now be described in more detail with reference to FIGS. 1-2 in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, digital cameras, digital video cameras, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk, magnetic disk 29, optical disk 31, ROM 24 or RAM 25, including an operating system 35, one or more application programs 36, a photo location organizer program 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The photo location organizer program 60 will be described in more detail with reference to FIG. 2 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more servers, such as a server 49. The server 49 may be another personal computer, a remote computer, a router, a network PC, a peer device or other common network node. The server 49 may include internet service sites such as Microsoft MapPoint®, Microsoft Virtual Earth®, or another similar reverse-geocoding web based service. Although the server 49 is illustrated as having only a memory storage device 50, the server 49 may include many or all of the elements described above relative to the computing system 100. The memory storage device 50 may contain a world map database 61 and a reverse-geocoding application 62. The world map database 61 may contain textual information pertaining to any part of the planet Earth including street addresses, parks, shopping centers, cities, states, countries, and the like. The reverse-geocoding application 62 may provide an address or toponym given a set of latitude and longitude coordinates. Although it has been described that the world map database 61 and the reverse-geocoding application 62 may be stored on the memory storage device 50 of the server 49, it should be understood that the world map database 61 and the reverse-geocoding application 62 may be stored in the local hard drive 27 or in the system memory 22 of the computing system 100 or in combinations thereof. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates flow diagram of a method 200 for adding location references to picture files in accordance with one or more implementations of various techniques described herein. Location references may also be referred to as location information.

At step 205, the photo location organizer program 60 may receive a batch of picture files, wherein each picture file may or may not contain a location reference embedded within its file. The batch of picture files may be received from the memory of a digital camera, a Universal System Bus (USB) memory device, the hard drive of a local machine, downloaded from a web site/service or via e-mail, or any other type of memory.

At step 210, the photo location organizer program 60 may scan all of the picture files contained in the batch and identify the picture files that contain a location reference embedded therein and the picture files that do not contain a location reference embedded therein. In one implementation, the photo location organizer program 60 may also determine that certain picture files without location references may be related to other picture files with location references based on factors such as how close in time the pictures may have been taken. For example, the photo location organizer program 60 may group a set of pictures without location references with one or more pictures with location references based on the fact that all of the pictures may have been taken within a ten minute lapse of time.

At step 215, the photo location organizer program 60 may provide the user with an option to embed a location reference to one or more of the picture files in the batch that may be lacking location references, or it may allow the user to modify the location reference of one or more picture files that contain already location reference. In one implementation, the option to embed or modify the location references of picture files may be performed on a user interface (UI) of the photo location organizer program 60 by associating a picture with its locations on a digital map. For example, the user may use the pointing device 42 to drag an icon representing a specific picture to a location on a map representing the location in which the picture was taken. Depending on the zoom level of the map, the photo location organizer program 60 may embed the latitude and longitude coordinates as well as a parameter indicating the precision of these coordinates into the picture file as its location reference. The precision of the coordinates, or level of precision, may depend on how far the map is zoomed in when the user drags the icon representing the picture file into the digital map. The level of precision may indicate how much of the surrounding general location area may encompass on the location reference. For instance, if the level of precision is high, the location reference may describe a street address; while a low level of precision may only list the country as the location reference of a picture file. Although the method 200 has been described as providing an option to embed or modify a location reference to one or more picture files prior to determining the locations of picture files that do not contain location references, it should be noted that this option may not be provided in some implementations. Instead, the photo location organizer program 60 may skip step 215 and move to step 220.

In one implementation, the photo location organizer program 60 may determine the level of precision by interpreting the user's movement of the pointing device 42 or the movement of the user's finger given a touch-input device. The pointing device 42 may be more precise than a user's finger, which may affect the level of precision of the location reference.

At step 220, the photo location organizer program 60 may send a request to the server 49 to determine a location hierarchy for the location reference of each picture file with a known location. The picture file with a known location may include picture files that contain location references within the file. The picture files with known locations may have been obtained from a camera with a built-in GPS device or a program that associates picture files with location references with a GPS logger. The picture files with known locations may also include picture files wherein a location reference may have been added by the user with the photo location organizer program 60 as described at step 215. The location hierarchy may be described as a loose hierarchal location structure such that the location reference embedded in the picture file may be organized into a loose hierarchy from least specific at the top (e.g., USA) to most specific at the bottom (e.g., a street address). That is, the location hierarchy may be defined as having lower levels and higher levels. Higher levels of the location hierarchy may correspond to the least specific while lower levels correspond to the most specific. For example, a set of latitude and longitude coordinates indicating a street corner in Seattle, Wash. may have a location hierarchy such that the street corner is the lowest point on the hierarchy. One level above that may be the city wherein the latitude and longitude coordinates are located. The next levels above the city may include the county, state, country, and ultimately the planet Earth, but the location hierarchy may also include more general location areas such as “Puget Sound” or “Greater Seattle.”

The server 49 may use the reverse-geocoding application 62 to compare the location reference embedded within a picture file to the locations listed in the world map database 61. The reverse-geocoding application 62 may use the world map database 61 to determine the location hierarchy of the location reference in the picture file. The server 49 may then send the location hierarchy of each provided picture file's location reference to the photo location organizer program 60. Although in this implementation the world map database 61 and the reverse-geocoding application 62 are shown to be stored on the server 49, it should be understood that the world map database 61 and the reverse-geocoding application 62 may be stored in the system memory 22 or the hard drive 27 of the computing system 100.

At step 225, the photo location organizer program 60 may receive the location hierarchy of a picture file with a known location from the server 49. In one implementation, the photo location organizer program 60 may write the received location hierarchy into the Exchangeable image format (Exif), Extensible Metadata Platform (XMP), International Press Telecommunications Council's (IPTC) Information Interchange Model (IIM), or other metadata portion of the picture file. This process may be repeated for each picture file in the batch containing a location reference embedded within the file.

At step 230, the photo location organizer program 60 may fix each picture file with a location reference onto a chart, graph, or other type of data structure with respect to each picture file's time reference embedded within the file. The time reference for each picture file may be obtained from a time stamp embedded in the picture file indicating the time in which the picture was taken. The chart, graph, or other type of data structure may be used by the photo location program 60 to represent the time-space relationship of each picture file. In one implementation, the time-space representation of the picture files may not be displayed to the user; instead, it may be used as a means for the photo location organizer program 60 to store the time-space information pertaining to each picture file with a known location in an organized manner that may be used later at step 235.

At step 235, the photo location organizer program 60 may calculate the location reference of the picture files with unknown locations. The photo location organizer program 60 may use the time reference of the picture files with unknown locations and the picture files fixed onto the data structure established in step 230 as inputs into one or more algorithms for determining the location reference of each picture file with an unknown location.

At step 235, the photo location organizer program 60 may employ one or more algorithms in determining the locations of the picture files with unknown locations. The algorithms may be based on (a) the time-space relationship between picture files with known and unknown locations, (b) the time-cluster relationship between groups/clusters of picture files with known and unknown locations, (c) other types of time sensitive relationships, or combinations thereof. In one implementation (a), the photo location organizer program 60 may compare the difference in time between picture files with known locations and pictures with unknown locations as a means of determining the location of pictures with unknown locations. The photo location organizer program 60 may compare the time between when a picture with a location reference (fixed picture) was taken and the time when the next picture file without a location reference (relative picture) was taken. Depending on the amount of time that expired between the fixed picture file and the next relative picture, the photo location organizer program 60 may calculate the level of precision for the location of the relative picture. As the time between the fixed picture and relative picture increases, the photo location organizer program 60 may decrease the level of precision associated with the relative file. The photo location organizer program 60 may use the level of precision to determine how far from the fixed picture may the relative picture be. As the level of precision decreases, the photo location organizer program 60 may remove or trim the lower levels of the location hierarchy of the fixed picture and associate the resulting location hierarchy with the relative picture.

For example, the first fixed picture may indicate to the photo location organizer program 60 that the picture was taken at 11:00:00 a.m. on the corner of John and Broad streets in Seattle, Wash. The next picture may have been taken at 12:00:00 p.m., but the picture file does not have a location reference embedded into its file (relative picture). The photo location organizer program 60 may use an algorithm to determine the level of precision associated with the relative file based on the fact that an hour has expired since the fixed picture was taken. In this example, the level of precision may indicate to the photo location organizer program 60 that the location of the relative picture has changed such that the program cannot assume that the picture was taken on the street corner of John and Broad streets. Instead, the photo location organizer program 60 may remove or trim the bottom levels of the fixed picture's location hierarchy such that the lowest level of the hierarchy only indicates the state of Washington. The photo location organizer program 60 may then embed the resulting trimmed location hierarchy of the fixed picture into relative picture file such that the relative picture file's location hierarchy may not contain a sub-level after the state, Washington. The photo location organizer program 60 may then consider the relative picture as its new fixed picture and seek the next relative picture taken in time and determine its location using a similar method as described above.

In a similar example, if the fixed picture is taken at 11:00:00 a.m. and the next relative picture is taken at 11:00:01 a.m., the photo location organizer program 60 may determine that the level of precision between the fixed picture and the relative picture is almost the same because it is unlikely that the user traveled very far within one second. Therefore, the photo location organizer program 60 may not trim any part of the location hierarchy of the fixed picture and it may use the entire location hierarchy of the fixed picture for the relative picture. Although it has been described that the fixed picture may have a location reference with a high level of precision, such as a street corner, it should be understood that the level of precision for the fixed picture may be lower if the location hierarchy was obtained using the drag and drop UI of the photo location organization program 60 as described in step 215 wherein the digital map was zoomed out such that a pixel on the user's screen represented several city blocks.

In another implementation based on the time-space relationship between picture files with known and unknown locations (a), the algorithm may interpolate the latitude and longitude coordinates of the picture files with unknown locations taken at times before and after picture files with known locations were taken. For example, if picture 2 is taken at 12:00:00 p.m. at an unknown location, picture 1 is taken at 11:00:00 a.m. in Philadelphia, Pa., and picture 3 is taken at 1:00:00 p.m. in New York, N.Y., the photo location organizer program 60 may interpolate a set of latitude and longitude coordinates to indicate that picture 2 may have been taken in New Jersey (one hour in between Philadelphia and New York). Along with the set of latitude and longitude coordinates for picture 2, the photo location organizer program 60 may associate a level of precision with the set of coordinates based on the time difference between when picture 1 and picture 2 were taken, the time difference between when picture 2 and picture 3 were taken, the level of precision associated with picture 1, the level of precision associated with picture 3, or combinations thereof. In this example, the photo location organizer program 60 may then send a request to the server 49 to determine a location hierarchy for the interpolated set of latitude and longitude coordinates. The photo location organizer program 60 may then trim the received location hierarchy as per the level of precision obtained for the interpolated set of latitude and longitude coordinates.

In another implementation (b), the photo location organizer program 60 may use time-based clusters of picture files as a way of determining the location reference of a picture file with an unknown location. Time-based clusters may be determined by distinguishing a set of picture files within a batch of picture files based on the times in which the set of picture files may have been taken. Time-based clusters may group picture files such that the average number of photos taken during a certain amount of time may be higher than a defined minimum threshold. For example, a batch of picture files may contain a group of picture files wherein ten pictures may have been taken during a two minute interval. Here, the average number of pictures taken during the two minute interval is five pictures per minute. If the defined minimum threshold is four pictures per minute, the ten pictures taken within the two minute interval may be defined as a time-based cluster. Alternatively, time-based clusters may otherwise be determined by locating gaps along the time dimension that are greater than a given value (e.g., if there is more than thirty minutes without any new picture files). The time-based clusters may also be determined by analyzing the total duration of the cluster such that if the duration is one hour, then thirty minutes is likely to be considered significant. However, if the total duration of the cluster is several days, then thirty minutes is not likely to be considered significant. The photo location organizer program 60 may determine that the level of precision for a time-based cluster of picture files will be relatively the same for each picture file in the cluster because it is likely that all of the pictures may have been taken at or near the same location. In each of the above cases (a & b), the output location reference may be associated with a level of precision that may help determine how much of the location hierarchy can be trimmed and how much of the location hierarchy can be propagated.

At step 240, the photo location organizer program 60 may embed the location hierarchy output of the algorithm into the picture file with unknown location. In one implementation, the photo location organizer program 60 may permanently alter the picture file such that the location reference is stored in the file and any copy of the picture file may also contain its location reference. Alternatively, the photo location organizer program 60 may output the location reference to a separate file, e.g., a sidecar that is associated with the original picture file.

At step 245, the photo location organizer program 60 may display the locations of all of the picture files of the batch on its UI so that the user may verify the accuracy of the location reference for each picture file. In one implementation, the UI of the photo location organizer program 60 may display the location of each picture file by placing an icon on a digital map for each picture file. Although the location reference of the picture files may be indicated with the use of a digital map, it should be understood that the photo location organizer program 60 may indicate the location of the picture file in another manner such as text fields.

At step 250, the photo location organizer program 60 may receive a request from the user to alter the location reference of one or more picture files displayed at step 245. The user may wish to alter the location reference of one or more picture files because the one or more picture files may not indicate the correct location reference or the user's preferred level of precision. Here, the user may change the location reference of the one or more picture files by dragging an icon representing the picture to a location on a digital map as described in step 215.

At step 255, the photo location organizer program 60 may iterate through steps 215-240 in order to produce a more refined or accurate location reference for all of the picture files of the batch. Although it has been described that the photo location organizer program 60 may iterate through steps 215-240 immediately after completing steps 215-240 for the first time, it should be noted that the photo location organizer program 60 may receive a request to alter the location reference of a picture file at any time. Further, each time the photo location reference of any picture file is modified, the photo location organizer program 60 may refine the location references of all of the picture files with calculated or unknown locations by iterating through steps 215-240 again.

Although the photo location organizer program 60 has been described to embed the location references for picture files, it should also be noted that other media files may also have location references embedded within their files such as digital video files and the like. In one implementation, digital video files may be considered to be a batch of picture files linked together in time. As a result, each picture file in a digital video file may have a location reference embedded within the picture file using the same techniques as described in method 200. However, the location references of picture files within a video file may only be calculated for certain picture files at specific intervals of time due to the volume of picture files contained within a video file. For instance, for short video clips (e.g. one minute), the location reference for only one of the picture files in the one minute video may be determined. However, for longer video clips, location references may be determined for one picture file at regular or irregular intervals during the video because the digital video files may contain various locations from the start to the end of the video. Although the location reference for digital video files has been described as a batch of picture files linked together in time wherein each picture file may have a location reference embedded within the file, it should be noted that in one implementation, digital video files may have location references stored on one or more separate sidecar files.

Further, it should be understood that that the photo location organizer program 60 may use different types of media files such as video or picture files to determine the location reference a media file. For example, a picture file and a video file may both be obtained using the same recording device, and thus the photo location organizer program 60 may use the available location reference of either file to determine the location reference of the other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating location information for a digital media file, comprising:
receiving a first digital media file with location information and a second digital media file without location information;
receiving a location hierarchy of the first digital media file, wherein the location hierarchy is determined using a reverse-geocoding algorithm; and
using the location hierarchy of the first digital media file to determine a location hierarchy of the second digital media file.

2. The method of claim 1, further comprising embedding the location hierarchy of the first digital media file into the first digital media file.

3. The method of claim 1, further comprising sending a request to a server to obtain the location hierarchy of the first digital media file.

4. The method of claim 3, wherein the server uses the reverse-geocoding algorithm to determine the location hierarchy.

5. The method of claim 1, further comprising receiving the location information of the first digital media file from a user.

6. The method of claim 5, wherein the location information comprises a level of precision value.

7. The method of claim 1, wherein using the location hierarchy to determine the location hierarchy of the second digital media file comprises:
fixing the first digital media file and the second digital media file to a data structure; and
using the data structure to represent a time space relationship of the first digital media file and the second digital media file.

8. The method of claim 1, wherein using the location hierarchy to determine the location hierarchy of the second digital media file further comprises:
calculating a level of precision for a location of the second digital media file based on a difference in time between when the first digital media file was taken and when the second digital media file was taken; and
using the level of precision to determine the location hierarchy of the second digital media relative to the first digital media.

9. The method of claim 8, wherein using the location hierarchy to determine the location hierarchy of the second digital media file further comprises removing one or more lower levels of the location hierarchy of the first digital media file to determine the location hierarchy of the second digital media file.

10. The method of claim 1, wherein the location hierarchy of the second digital media file is determined using time-based cluster algorithms.

11. The method of claim 1, further comprising embedding the location hierarchy of the second digital media file in the second digital media file.

12. The method of claim 1, further comprising displaying the location hierarchy of the first digital media file and the location hierarchy of the second digital media file.

13. The method of claim 1, wherein the digital media file is a picture file.

14. The method of claim 1, wherein the digital media file is a video file.

15. A computer-readable medium having stored thereon computer-executable instructions which, when executed by a computer, cause the computer to:
receive one or more digital picture files;
identify a first set of digital picture files with location information and a second set of digital picture files without location information;
receive a location hierarchy of each digital picture in the first set of digital picture files;
use the location hierarchy of each digital picture in the first set of digital picture files to determine a location hierarchy of each digital picture in the second set of digital picture files.

16. The computer-readable medium of claim 18, wherein the computer-executable instructions which, when executed by a computer, cause the computer to use the location hierarchy to determine the location hierarchy of each digital picture in the second set of digital picture files comprises computer-executable instructions which, when executed by a computer, cause the computer to:
calculate a level of precision for a location of each digital picture file in the second set of digital picture files based on a difference in time between when the first set of digital picture files were taken and when the second set of digital picture files were taken; and
use the level of precision to determine the location hierarchy of each digital picture file in the second set of digital picture files relative to the first set of digital picture files.

17. The computer-readable medium of claim 18, further comprising computer-executable instructions which, when executed by a computer, cause the computer to embed the location hierarchy of each digital picture file in the second digital picture files in the second set of digital picture files.

18. A computer system, comprising:
a processor; and
a memory comprising program instructions executable by the processor to:
receive a first digital media file with location information, a second digital media file without location information, and a third digital media file with location information;
determine the location information of the second digital media file using the location information of the first digital media file and the location information of the third digital media file.;
receive a first location hierarchy of the second digital media file;
calculate a level of precision for a location of the second digital media file based on a difference in time between when the first digital media file was taken and when the second digital media file was taken, a difference in time between when the third digital media file was taken and when the second digital media file was taken, the level of precision of the first digital media file, the level of precision of the third digital media file, or combination thereof; and
remove one or more lower levels of the location hierarchy of the second digital media file to determine a second location hierarchy of the second digital media file.

19. The computer system of claim 18, wherein the memory further comprises program instructions executable by the processor to embed the location hierarchy of the first digital media file in the first digital media file.

20. The computer system of claim 18, wherein the digital media file is a picture file.
